(19) United States
(12) Patent Application Publication
(10) Pub. No.: US 2015/0188733 A1
(43) Pub. Date: Jul. 2, 2015

(54) METHOD FOR REMOVING SIGNAL INTERFERENCE BASED ON MULTIPLE INPUT MULTIPLE OUTPUT

(71) Applicant: Electronics and Telecommunications Research Institute, Daejeon (KR)

(72) Inventors: Jinhyung OH, Daejeon (KR); Gwangzeen KO, Daejeon (KR); Igor KIM, Daejeon (KR); Myung Sun SONG, Daejeon (KR); Hyun Ho LEE, Seoul (KR); Myeong Jin KIM, Seoul (KR); Young Chai KO, Seoul (KR)

(73) Assignee: Electronics and Telecommunications Research Institute, Daejeon (KR)

(21) Appl. No.: 14/272,973

(22) Filed: May 8, 2014

(30) Foreign Application Priority Data
Dec. 30, 2013 (KR) 10-2013-0166381

(51) Int. Cl. H04L 25/03; H04L 25/02

(52) U.S. Cl. CPC H04L 25/0391; H04L 25/0202; H04B 7/0452

(57) ABSTRACT

Disclosed is a method for removing signal interference in a MIMO-based interference removing apparatus including transmitting a reference signal to at least one receiver; if channel information is estimated by the receiver, receiving the estimated channel information from the receiver as a feedback signal; and producing transmission pre-coding matrix, beam forming matrix, and weighted matrix using the received channel information. Further, the method includes transmitting information containing the transmission pre-coding matrix, the beam forming matrix, and the weighted matrix by including them in a pilot signal to the receiver, and the MIMO-based interference removing apparatus comprises at least one transmitter.

### CROSS-REFERENCE TO RELATED APPLICATION(S)

The present invention claims priority to and the benefit of Korean Patent Application No. 10-2013-0166381, filed on Dec. 30, 2013, the entire contents of which is incorporated herein by reference.

### FIELD OF THE INVENTION

The present invention relates to a method for removing signal interference based on MIMO (Multiple Input Multiple Output), and more particularly, to a method for removing interference that is robust to channel estimation error even in an environment of multiple wireless LAN (Local Area Network) APs (Access Points) and wireless terminals.

### BACKGROUND OF THE INVENTION

In a multiple antenna wireless LAN environment, wireless APs shares the same wireless resources one another in order to maximize efficiency of the wireless resources. In this case, overall network performance may be deteriorated due to influence caused by inter-user interference and inter-AP interference.

One of the methods to remove the signal interference is done by transmitting frames without the occurrence of interference in transmission and reception of the frames. In this connection, Korean Laid-Open Patent Publication No. 2012-0127833 (laid-open published on Nov. 26, 2012) discloses an arrangement for acquiring interference channel information between a station (STA) and its adjacent STA which is a frame transmission target of a wireless LAN AP, deciding a transmission beam vector based on the interference channel information, and transmitting data frames to the transmission target STA in a MINO transmission manner based on the transmission beam vector.

However, in providing the method of removing the interference, prior arts fail to take into consideration of channel estimation error or describe an interference removal method robust to the channel estimation error in a situation where multiple wireless LAN APs and wireless terminals are equipped with multiple antennas.

### SUMMARY OF THE INVENTION

In view of the above, the present invention provides a method for removing signal interference based on MIMO capable of minimizing influence of the interference signal in spite of acquiring incorrect channel information in a network having a plurality of wireless LAN APs.

In accordance with an embodiment of the present invention, there is provided a method for removing signal interference in a MIMO-based interference removing apparatus. The method includes transmitting a reference signal to at least one receiver; if channel information is estimated by the receiver, receiving the estimated channel information from the receiver as a feedback signal; producing transmission pre-coding matrix, beam forming matrix, and weighted matrix using the received channel information; and transmitting information containing the transmission pre-coding matrix, the beam forming matrix, and the weighted matrix by including them in a pilot signal to the receiver, wherein the MIMO-based interference removing apparatus comprises at least one transmitter.

In accordance with any one of solutions to the aforementioned subject of the present invention, it is possible to reduce influence of the interference signal in spite of acquiring incorrect channel information in a network having a plurality of wireless LAN APs.

### BRIEF DESCRIPTION OF THE DRAWINGS

The above and other objects and features of the present invention will become apparent from the following description of the embodiments given in conjunction with the accompanying drawings, in which:

FIG. 1 is a configuration diagram illustrating a system for removing signal interference based on MOMO in accordance with an embodiment of the present invention;

FIG. 2 is a block diagram illustrating an apparatus for removing interference based on MOMO shown in FIG. 1;

FIG. 3 shows a diagram explaining the signal interference occurred in the MIMO-based interference removing system of FIG. 1;

FIG. 4 is a sequential diagram illustrating a process of transmitting and receiving data between components of the MIMO-based interference removing system of FIG. 1 in accordance with an embodiment of the present invention;

FIG. 5 is a flow chart describing a detailed operation in block S4400 of FIG. 4; and

FIG. 6 is a flow diagram illustrating a method for removing signal interference based on MOMO in accordance with an embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

Throughout the specification and the claims, when an element is described as being “connected” to another element, this implies that the elements may be directly connected together or the elements may be connected through one or more intervening elements. Furthermore, when an element is described as “including” one or more elements, this does not exclude additional, unspecified elements, nor does it preclude the presence or addition of one or more other features, integers, steps, operations, elements, components and/or groups thereof.

Hereinafter, the embodiments of the present invention will be described in detail with reference to the accompanying drawings which form a part hereof.

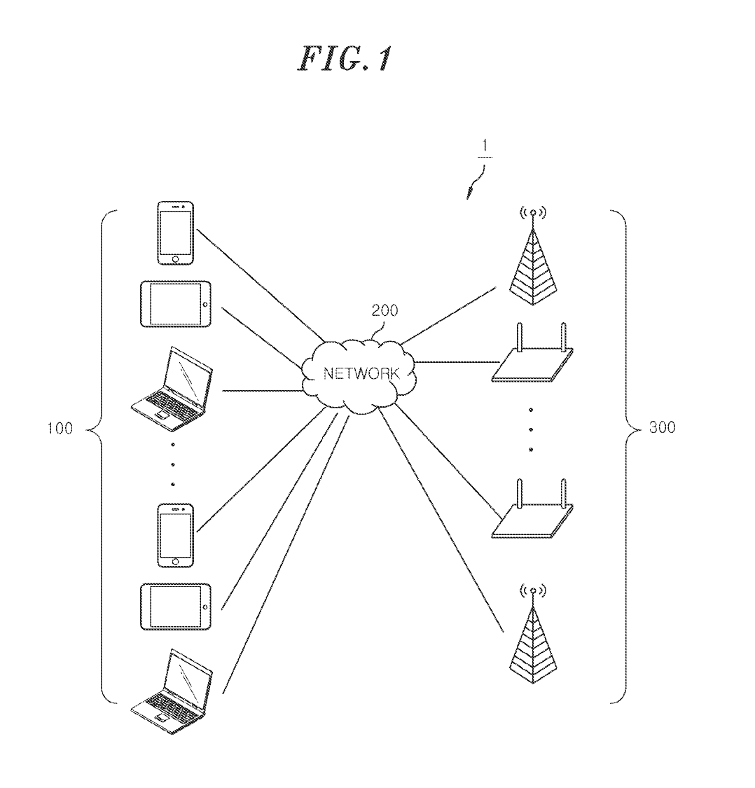

FIG. 1 is a configuration diagram illustrating a system for removing signal interference based on MOMO in accordance with an embodiment of the present invention. Referring to FIG. 1, a MIMO-based interference removing system 1 may include at least one receiver 100 and at least one transmitter 250. However, the MIMO-based interference removing system 1 shown in FIG. 1 is only an illustrative example, and it is understood that the embodiment of the present invention is not limited to that illustrated in FIG. 1.

The respective components of FIG. 1 are typically connected through a network 200. For example, as shown in FIG. 1, the receiver(s) 100 and the transmitter(s) 250 are connected via the network 200. The network 200 used herein refers to a physical connection topology capable of exchanging information between the respective nodes such as terminals and servers, which may include, e.g., the Internet, LAN (Local Area Network), Wireless LAN (Local Area Network), WAN (Wide Area Network), PAN (Personal Area Network), 3G network, 4G network, LTE network, Wi-Fi network, or the like but is not limited thereto. Further, it is understood that the receiver 100 and the transmitter 250 are also not limited to those illustrated in FIG. 1.

The receiver 100 may be, e.g., a wireless terminal. Also, the receiver 100 may be the basis of MIMO antenna. The receiver 100 may be implemented by a wireless communication device that ensures portability and mobility, for example, which may include any kind of handheld-based wireless communication devices such as a handset for PCS (Personal Communication System), GSM (Global System for Mobile communications), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (W-Code Division Multiple Access), and Wibro (Wireless Broadband Internet), smartphone, smart pad, Tablet PC, or the like.

The transmitter may be, for example, a wireless LAN AP or a repeater. In this case, the transmitter may serve at least one receiver. Further, the transmitter 250 may be the basis of a MIMO antenna.

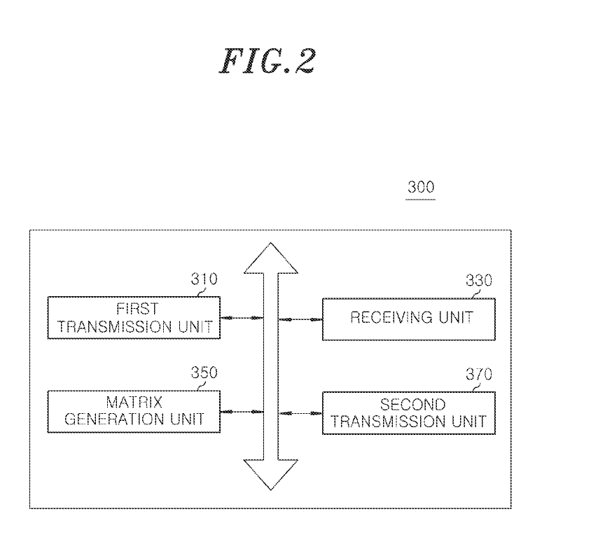

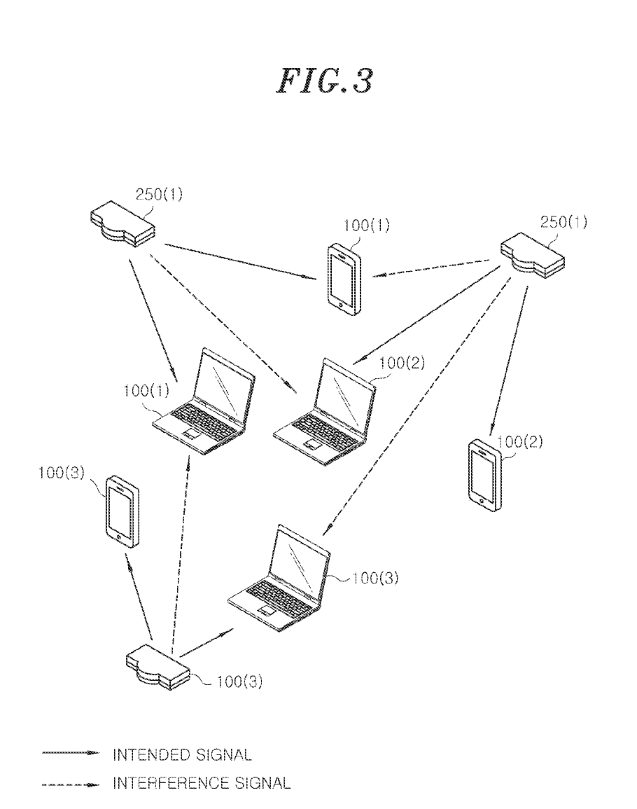

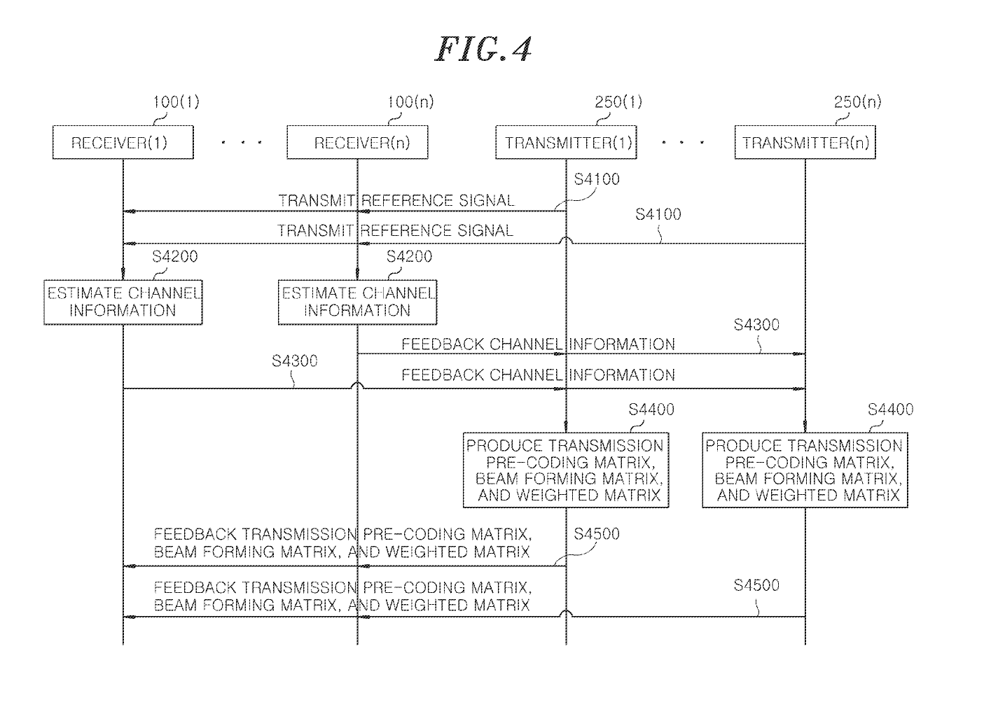

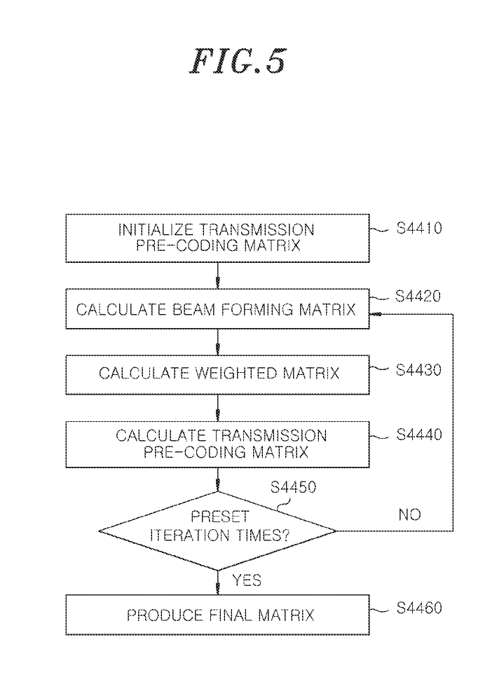

FIG. 2 is a block diagram illustrating an apparatus for removing signal interference based on MOMO shown in FIG. 1, FIG. 3 shows a diagram explaining the interference occurred in the MIMO-based interference removing system of FIG. 1, FIG. 4 is a sequential diagram illustrating a process of transmitting and receiving data between the components of the MIMO-based interference removing system of FIG. 1, and FIG. 5 is a flow chart describing a detailed operation in block S4400 of FIG. 4.

Describing with reference to FIG. 2, a MOMO-based interference removing apparatus 300 may include a first transmission unit 310, a receiving unit 330, a matrix generation unit 350, and a second transmission unit 370.

Herein, the MOMO-based interference removing apparatus 300 may be incorporated into the transmitter 250, may be one of components of the transmitter 250, or may be a program or an operating system embedded in the transmitter 250. However, it is not intended to limit the embodiment to the foregoing implements.

Referring to FIGS. 2 and 4, the first transmission unit 310 of the transmitter 250 transmits a reference signal to at least one (hereinafter, referred to as a representative reference numeral 100) of the receivers 100(1) to 100(N) (in block S4100).

When channel information is estimated in the receiver 100 (in block S4200), the receiving unit 330 receives the estimated channel information as a feedback signal from the receiver 100 (in block S4300).

The matrix generation unit 350 generates transmission pre-coding matrix, beam forming matrix and weighted matrix (in block S4400). The operation of the matrix generation unit 350 will be explained in detail with reference to FIG. 5 as follows. Specifically, the matrix generation unit 350 initializes the transmission pre-coding matrix with respect to the transmitter 250 and the receiver 100 (in block S4410) and calculates the beam forming matrix with respect to the transmitter 250 and the receiver 100 (in block S4420).

The beam forming matrix may be calculated by the following Equation 1.

U^{[k,i]}=Φ^{[k,i]-1}Hᵢ^{[k,i]}V^{[k,i]} [EQUATION 1]

wherein Φ^{[k,i]} represents a covariance matrix of the signal that is received by any one of the receivers 100, Hᵢ^{[k,i]} represents a channel matrix between any one of the transmitters 250 and any one of receivers 100, V^{[k,i]} represents a transmission ore-coding matrix for any one of the receivers 100. The Equation 1 is intended for minimizing MSE (Mean Square Error).

The channel matrix may be calculated by the following Equation 2. Herein, an i-th transmitter 250(i) has Mᵢ antennas and supports Kᵢ receivers having Nᵢ antennas. A k-th terminal (or receiver) that is supported by a j-th transmitter 300(j) is expressed as [k,i]. Hᵢ^{[k,i]} represents a channel matrix between i-th transmitter 250(i) and a receiver 100 [k,j].

Referring to FIG. 3, undesirable errors may occur between a real channel matrix and the estimated channel information acquired by the transmitter 250 because of various factors such as incorrect channel estimation, quantization error or feedback error due to an interference signal and an intended signal. Under such situation, the real channel may be expressed as the following Equation 2.

Hᵢ^{[k,j]}=\tilde{H}ᵢ^{[k,j]}+Δᵢ^{[k,j]} [EQUATION 2]

where \tilde{H}ᵢ^{[k,j]} denotes an estimated channel matrix, Δᵢ^{[k,j]} denotes a channel estimation error matrix, the elements of the channel matrix and the channel estimation error matrix are complex Gaussian random variables whose mean is zero (0) and variance is σₑ².

The covariance matrix of the signal that is received by the receiver [k,j] may be calculated by the following Equation 3.

$${Φ}^{[ k , i ]} = ( {σ}_{n}^{2} + {σ}_{e}^{2} {\sum }_{( 1 , j )} tr \{ {V}^{[ 1 , j ]} {V}^{[ 1 , j ] H} \} ) I + {\sum }_{( 1 , j )} {H}_{j}^{[ k , i ]} {V}^{[ 1 , j ]} {V}^{[ 1 , j ] H} {H}_{j}^{[ k , i ] H} \qquad [ EQUATION 3 ]$$

where σₑ² denotes a variance value of noise influenced on the receiver 100.

In a situation where the channel estimation error exists, each of the transmission pre-coding matrix, the beam forming matrix and the weighted matrix may be calculated under the assumption that the remaining matrixes are fixed in order to exclude the dependence between the matrixes. Further, in order to minimize a weighted sum MSE, the weighted matrix of the receiver 100 [k,i] may be calculated by the following Equation 4.

W^{[k,i]}=(I−V^{[k,i]H}\tilde{H}ᵢ^{[k,i]H}Φ^{[k,i]-1}\tilde{H}ᵢ^{[k,i]}V^{[k,i]})⁻¹ [EQUATION 4]

where W^{[k,i]} denotes the weighted matrix.

When it is assumed that the beam forming matrix and the weighted matrix are all fixed, the pre-coding matrix that is used to minimize the weighted sum MSE may be derived through the Lagrange Multiplier Method. In accordance with an embodiment of the present invention, the transmission pre-coding matrix can be calculated by two methods as follows. A first method is a case where a transmission power of any one of the transmitters 250 is constrained whereas a second method is a case where a transmission power of any one of the receivers 100 is constrained.

In the first method, the transmission pre-coding matrix is calculated by the following Equation 5.

$${V}^{[ k , i ]} = {( \begin{matrix}{\sum }_{( i , j )} {μ}^{[ 1 , j ]} {\tilde{H}}_{i}^{[ 1 , j ] H} {U}^{[ 1 , j ]} {W}^{[ 1 , j ]} {U}^{[ 1 , j ] H} {\tilde{H}}_{i}^{[ 1 , j ]} + \\ {σ}_{e}^{2} {\sum }_{( i , j )} {μ}^{[ 1 , j ]} tr \{ {W}^{[ 1 , j ]} {U}^{[ 1 , j ] H} {U}^{[ 1 , j ]} \} I + {λ}_{i} I\end{matrix} )}^{- 1} \times {μ}^{[ k , i ]} {\tilde{H}}_{i}^{[ k , i ] H} {U}^{[ k , i ]} {W}^{[ k , i ]} \qquad [ EQUATION 5 ]$$

where μ^{[k,i]} denotes the priority of any one of the receivers 100; λᵢ denotes a Lagrange Multiplier of any one of the transmitters 250, which selects a value satisfying

$${\sum }_{k = 1}^{{K}_{i}} tr \{ {V}^{[ k , i ]} {V}^{[ k , i ] H} \} \leq {P}_{i} ;$$

and Pᵢ denotes an upper limit of the transmission power of any one of the transmitters 250.

In the second method, the transmission pre-coding matrix is calculated by the following Equation 6.

$${V}^{[ k , i ]} = ( \begin{matrix}{\sum }_{( i , j )} {μ}^{[ 1 , j ]} {\tilde{H}}_{i}^{[ 1 , j ] H} {U}^{[ 1 , j ]} {W}^{[ 1 , j ]} {U}^{[ 1 , j ] H} {\tilde{H}}_{i}^{[ 1 , j ]} + \\ \frac{{K}_{i}}{{P}_{i}} {σ}_{e}^{2} tr \{ {μ}^{[ k , i ]} {W}^{[ k , i ]} {U}^{[ k , i ] H} {U}^{[ k , i ]} \} I + \\ {σ}_{e}^{2} {\sum }_{( 1 , j )} tr \{ {μ}^{[ 1 , j ]} {W}^{[ 1 , j ]} {U}^{[ 1 , j ] H} {U}^{[ 1 , j ]} \} I\end{matrix} ) \times {μ}^{[ k , i ]} β {\tilde{H}}_{i}^{[ k , i ] H} {U}^{[ k , i ]} {W}^{[ k , i ]} \qquad [ EQUATION 6 ]$$

where β denotes a power normalization factor and Kᵢ denotes the number of the receivers 100 served by any one of the transmitters 250.

Meanwhile, the second transmission unit 370 may transmit information including the beam forming matrix and the weighted matrix by the inclusion of the information in a pilot signal. Upon receipt of the pilot signal, the receiver 100 produces a received beam forming matrix and transmit the same to the transmitter 250. The aforementioned processes are performed iteratively, thereby locating a point of convergence.

In other words, after obtaining the calculated beam forming matrix as described above, the weighted matrix is calculated with respect to the transmitter 250 and the receiver 100 (in block S4430), the transmission pre-coding matrix is calculated in case of constraining the transmission power of any one of the transmitters 250 or the transmission pre-coding matrix is calculated in case of constraining the transmission power of any one of the receivers 100 (in block S4440). Subsequently, the calculations are repeated until the weighted sum MSE of the weighted matrix converges on a predetermined threshold value (in block S4450), and a final matrix may then be produced (in block S4460). During the calculation, when the repetition is finished when the change in the weighted sum MSE is less than a predetermined threshold value or a preset iteration times come to end.

In accordance with an embodiment, when one of variables is calculated, it can be calculated by fixing the remaining variables in order to exclude the dependence between the variables.

Referring back to FIG. 4, the transmitter 250 transmits the beam forming matrix and the weighted matrix by including them in the pilot signal as a feedback signal to the receiver 100 (in block S4500).

The order of the operations described in blocks S4100 to s4500 is only an example and the embodiment is not limited thereto. Thus, the order of the operations in blocks S4100 to S4500 may be mutually exchanged, and some of these operations may be simultaneously executed or partially removed.

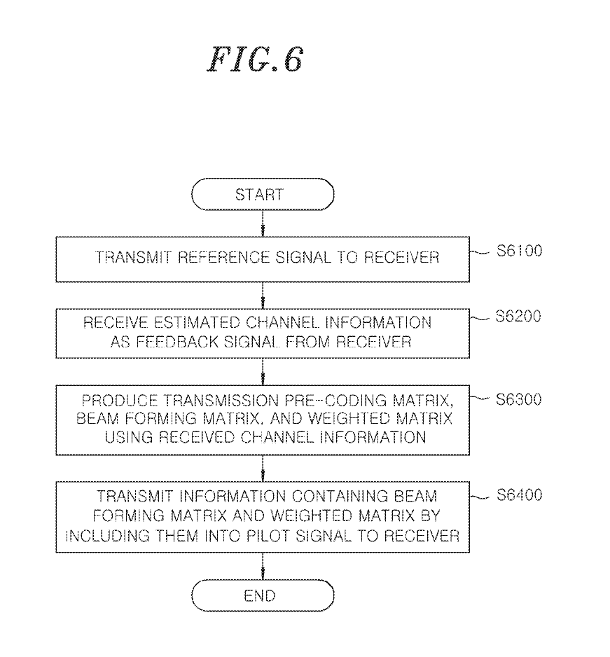

FIG. 6 is a flow diagram illustrating a method for removing signal interference based on MIMO in accordance with an embodiment of the present invention.

First, the MIMO based interference removing apparatus transmits a reference signal to the receiver (in block S6100).

Next, the MIMO based interference removing apparatus receives the estimated channel information that is estimated in the receiver as a feedback signal from the receiver (in block S6200).

The MIMO based interference removing apparatus then produces the transmission pre-coding matrix, the beam forming matrix and the weighted matrix using the received channel information (in block S6300), and transmits information including the beam forming matrix and the weighted matrix by the inclusion of them in the pilot signal to the receiver (in block S6400).

While the invention has been shown and described with respect to the embodiments, the present invention is not limited thereto. It will be understood by those skilled in the art that various changes and modifications may be made without departing from the scope of the invention as defined in the following claims.

What is claimed is:

1. A method for removing signal interference in a MIMO-based interference removing apparatus, the method comprising:
transmitting a reference signal to at least one receiver;
if channel information is estimated by the receiver, receiving the estimated channel information from the receiver as a feedback signal;
producing transmission pre-coding matrix, beam forming matrix, and weighted matrix using the received channel information; and
transmitting information containing the transmission pre-coding matrix, the beam forming matrix, and the weighted matrix by including them in a pilot signal to the receiver,
wherein the MIMO-based interference removing apparatus comprises at least one transmitter.

2. The apparatus of claim 1, wherein upon receiving the pilot signal, the receiver produces a received beam forming matrix and transmits it to the transmitter.

3. The apparatus of claim 1, wherein the transmitter comprises at least one wireless AP or at least one relay and the receiver comprises at least one wireless terminal.

4. The apparatus of claim 1, wherein said producing transmission pre-coding matrix, beam forming matrix, and weighted matrix using the received channel information comprises:
initializing the transmission pre-coding matrix with respect to the transmitter and the receiver;
calculating the beam forming matrix with respect to the transmitter and the receiver;
calculating the weighted matrix with respect to the transmitter and the receiver;
calculating transmission pre-coding matrix in case of constraining a transmission power of any one of transmitters, or transmission pre-coding matrix in case of constraining a transmission power of any one of receivers; and
repeatedly performing the calculations until the weighted sum MSE of the weighted matrix converges on a predetermined threshold value.

5. The apparatus of claim 1, wherein the beam forming matrix is calculated by the following equation:
U^{[k,i]}=Φ^{[k,i]-1}Hᵢ^{[k,i]}V^{[k,i]}
wherein Φ^{[k,i]} represents a covariance matrix of the signal that is received by any one of the receivers, Hᵢ^{[k,i]} represents a channel matrix between any one of the transmitters and any one of receivers, and V^{[k,i]} represents a transmission pre-coding matrix for any one of the receivers.

6. The apparatus of claim 5, wherein the channel matrix is calculated by the following equation:
Hᵢ^{[k,j]}=\tilde{H}ᵢ^{[k,j]}+Δᵢ^{[k,j]}
where \tilde{H}ᵢ^{[k,j]} denotes an estimated channel matrix, Δᵢ^{[k,j]} denotes a channel estimation error matrix, and the elements of the channel matrix and channel estimation error matrix are complex Gaussian random variables whose mean is zero (0) and variance is σₑ².

7. The apparatus of claim 5, wherein the covariance matrix is calculated by the following equation:
$${Φ}^{[ k , i ]} = ( {σ}_{n}^{2} + {σ}_{e}^{2} {\sum }_{( 1 , j )} tr \{ {V}^{[ 1 , j ]} {V}^{[ 1 , j ] H} \} ) I + {\sum }_{( 1 , j )} {H}_{j}^{[ k , i ]} {V}^{[ 1 , j ]} {V}^{[ 1 , j ] H} {H}_{j}^{[ k , i ] H}$$
where σₑ² denotes a variance value of noise influenced on the receiver.

8. The apparatus of claim 7, wherein the transmission pre-coding matrix is calculated by the following equation:
W^{[k,i]}=(I−V^{[k,i]H}\tilde{H}ᵢ^{[k,i]H}Φ^{[k,i]-1}\tilde{H}ᵢ^{[k,i]}V^{[k,i]})⁻¹
where W^{[k,i]} denotes the weighted matrix.

9. The apparatus of claim 8, wherein the transmission pre-coding matrix is calculated by the following equation in cases where a transmission power of any one of the transmitters is constrained:
$${V}^{[ k , i ]} = {( \begin{matrix}{\sum }_{( i , j )} {μ}^{[ 1 , j ]} {\tilde{H}}_{i}^{[ 1 , j ] H} {U}^{[ 1 , j ]} {W}^{[ 1 , j ]} {U}^{[ 1 , j ] H} {\tilde{H}}_{i}^{[ 1 , j ]} + \\ {σ}_{e}^{2} {\sum }_{( i , j )} {μ}^{[ 1 , j ]} tr \{ {W}^{[ 1 , j ]} {U}^{[ 1 , j ] H} {U}^{[ 1 , j ]} \} I + {λ}_{i} I\end{matrix} )}^{- 1} \times {μ}^{[ k , i ]} {\tilde{H}}_{i}^{[ k , i ] H} {U}^{[ k , i ]} {W}^{[ k , i ]}$$
where μ^{[k,i]} denotes the priority of any one of the receivers 100, λᵢ denotes a Lagrange Multiplier of any one of the transmitters, which selects a value satisfying
$${\sum }_{k = 1}^{{K}_{i}} tr \{ {V}^{[ k , i ]} {V}^{[ k , i ] H} \} \leq {P}_{i} ,$$
and Pᵢ denotes an upper limit of the transmission power of any one of the transmitters.

10. The apparatus of claim 8, wherein the transmission pre-coding matrix is calculated by the following equation in case where a transmission power of any one of the receivers is constrained:
$${V}^{[ k , i ]} = ( \begin{matrix}{\sum }_{( i , j )} {μ}^{[ 1 , j ]} {\tilde{H}}_{i}^{[ 1 , j ] H} {U}^{[ 1 , j ]} {W}^{[ 1 , j ]} {U}^{[ 1 , j ] H} {\tilde{H}}_{i}^{[ 1 , j ]} + \\ \frac{{K}_{i}}{{P}_{i}} {σ}_{e}^{2} tr \{ {μ}^{[ k , i ]} {W}^{[ k , i ]} {U}^{[ k , i ] H} {U}^{[ k , i ]} \} I + \\ {σ}_{e}^{2} {\sum }_{( 1 , j )} tr \{ {μ}^{[ 1 , j ]} {W}^{[ 1 , j ]} {U}^{[ 1 , j ] H} {U}^{[ 1 , j ]} \} I\end{matrix} ) \times {μ}^{[ k , i ]} β {\tilde{H}}_{i}^{[ k , i ] H} {U}^{[ k , i ]} {W}^{[ k , i ]}$$
where β denotes a power normalization factor and Kᵢ denotes the number of the receivers related to any one of the transmitters.
